(19) United States
(12) Patent Application Publication
(10) Pub. No.: US 2013/0273518 A1
(43) Pub. Date: Oct. 17, 2013

(54) Portable Erasable Sign

(71) Applicant: James M. Papke, Rockton, IL (US)

(72) Inventor: James M. Papke, Rockton, IL (US)

(21) Appl. No.: 13/861,498

(22) Filed: Apr. 12, 2013

Related U.S. Application Data
(60) Provisional application No. 61/623,988, filed on Apr. 13, 2012.

(51) Int. Cl. G09B 25/00

(52) U.S. Cl. CPC G09B 25/00
USPC 434/408

(57) ABSTRACT

A portable, erasable sign for use in sporting events and public gatherings. The sign is self-supporting, but flexible enough to be carried and stored in a compact manner. The portable, erasable sign may include openings to facilitate holding of the sign. In certain embodiments, the sign may be rolled up when it is not being displayed. A strap, for example a Velcro strap, or an elastic band may be used to secure the sign in the rolled up position. The surface of the sign is such that any message printed thereon can be erased and replaced with a new message. In particular embodiments, the portable, erasable sign may be imprinted with the insignia for an organization, or a professional or university sports franchise.

### CROSS-REFERENCE TO RELATED PATENT APPLICATIONS

This patent application claims the benefit of U.S. Provisional Patent Application No. 61/623,988 filed Apr. 13, 2012, the entire teachings and disclosure of which are incorporated herein by reference thereto.

### FIELD OF THE INVENTION

This invention generally relates to signs, such as those typically displayed at sporting events and/or public gatherings.

### BACKGROUND OF THE INVENTION

At sporting events and at public gatherings such as conferences, concerts, political events, protests, and the like, the spectators and/or participants often display various signs, banners, placards, etc. The signs are often hand-written by the holder, and meant to show support for a sports team or player, for example, or to express an opinion, position or view to onlookers.

Typically, these signs are created before, perhaps long before, the event at which they are displayed. Further, the signs tend to be bulky and may be heavy depending on the material used to make the sign. Those created on rigid materials such as wood, thick cardboard and the like are durable, but can be heavy, difficult to transport. Those created from paper are lighter and easier to transport, but may be easily damaged and can be more difficult to display.

Further, typically these signs can display only one message, and therefore tend to be disposed of when the event for which they were created is over. It would therefore be desirable to have a sign with an erasable surface that allows for the display of multiple messages during a single event, and, due to this erasability, can be used in more than one event. U.S. Pat. No. 8,100,697, issued to Budryk et al., discloses a portable, retractable, erasable writing surface, while U.S. Patent Publication No. 2007/0006498, by Collins, discloses an erasable flexible sign with collapsible supports, both of which are incorporated herein in their entireties by reference thereto.

Embodiments of the present invention represent an advancement over the state of the art. These and other advantages of the invention, as well as additional inventive features, will be apparent from the description of the invention provided herein.

### BRIEF SUMMARY OF THE INVENTION

In one aspect, embodiments of the invention provide a portable, erasable sign that includes a self-supporting, erasable writing surface. In certain embodiments, the writing surface is configured to be sufficiently rigid such that no support members are used when the writing surface is displayed in a flattened configuration. Further, the writing surface is sufficiently flexible such that the writing surface can be rolled in to a substantially cylindrical shape when the writing surface is not being displayed. In particular embodiments, the writing surface is self-supporting when in a flattened state. The self-supporting, erasable writing surface may be a dry-erase surface on one or both sides. In a particular embodiment the erasable writing surface has a surface layer made from a thin film of non-porous material.

In a particular embodiment, the self-supporting writing surface includes at least one opening to facilitate holding of the sign by hand. In some embodiments, a center of the at least one opening is within four inches of a perimeter of the self-supporting, erasable writing surface. In certain embodiments, the writing surface has an elongated oval shape. In a more particular embodiment, the portable, erasable sign further comprises one of a strap and an elastic band to hold the sign in a rolled up position. The holding strap may include a fastening tape having two strips of material attached to the writing surface. One of the strips of material has a plurality of small, flexible hooks, while the other strip of material has a dense pile, such that the two strips interlock when pressed together. In an alternate embodiment, the holding strap is separate from the writing surface. In this embodiment, the strap has a fastening mechanism and is configured to wrap around and secure the writing surface in the rolled-up position.

The writing surface may be made from polystyrene or some suitable plastic material. In embodiments of the invention where the writing surface is made from polystyrene, the thickness of the writing surface is between 0.015 and 0.040 of an inch, or more preferably between 0.020 and 0.035 of an inch. In a more particular embodiment the thickness of the writing surface is approximately 0.030 of an inch. The writing surface may range from 11 to 36 inches in length, and from 8 to 26 inches in width, for example, and configured to be held and displayed by an individual. However, a writing surface configured to be displayed by two or more individuals may range from 5 to 10 feet in length, and from 30 to 50 inches in width.

In another embodiment of the invention, the writing surface is made from layered, flexible stainless steel or from plastic bi-stable spring bands, sealed within a polystyrene or plastic covering, which allows the writing surface to be adjusted between two positions, i.e., flat for writing and display and rolled up for transport, without any additional components or fastening members, such as straps or fastening tape, to secure the writing surface in the rolled up position.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIGS. 1A and 1B show a plan view and perspective view of a portable, erasable sign in both flattened state and in the rolled-up position, in accordance with an embodiment of the invention;

FIG. 2 is a plan view of a portable, erasable sign with elongated oval openings, in accordance with an embodiment of the invention; and

FIG. 3 is a plan view of a holding strap, according to an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

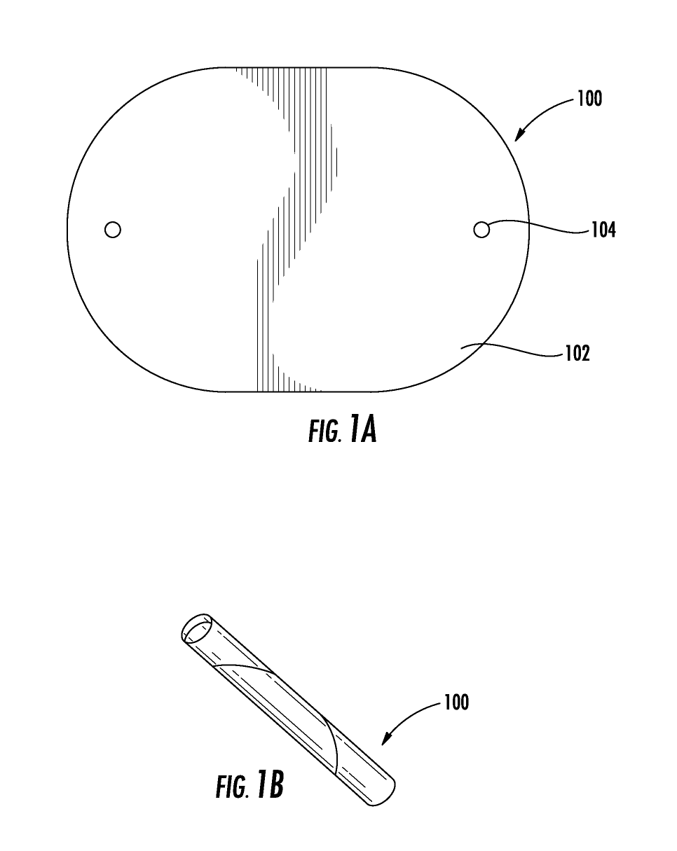

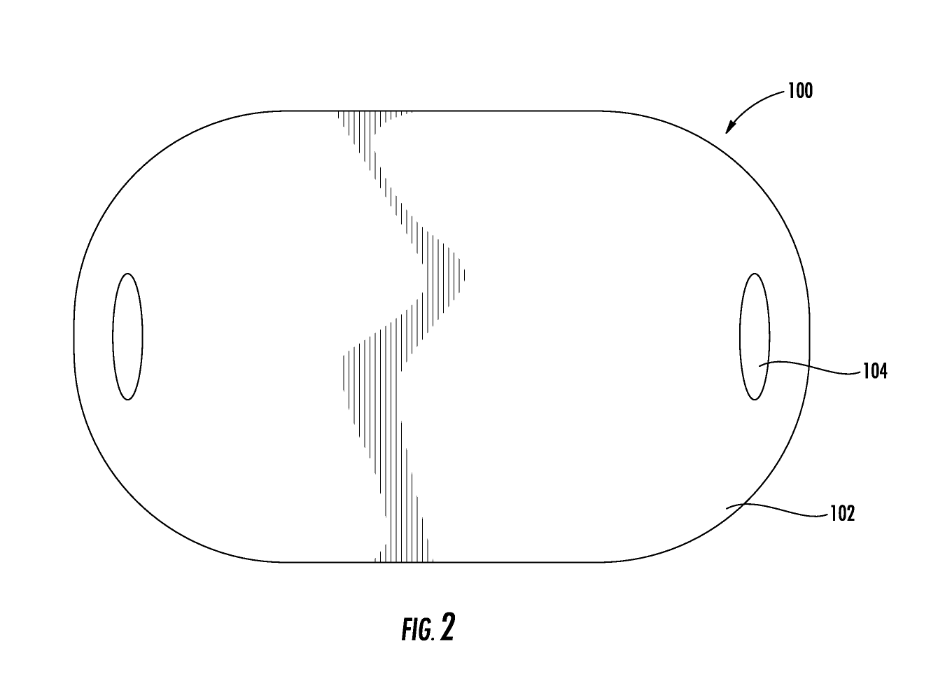

FIGS. 1A, 1B, and 2 show two plan views and a perspective view of the portable, erasable sign, constructed in accordance with an embodiment of the invention. In an embodiment of the invention, a portable, erasable sign 100 includes a self-supporting, erasable writing surface 102. In the context of the present invention, “self-supporting” means that the writing surface 102 is sufficiently rigid such that it can be displayed continuously without any supporting structural members, which are typically required for signs using paper or similarly flimsy materials. The self-supporting nature of the writing material means that no components, other than the writing surface 102, are required to construct the portable sign 100. This also means that messages can be easily written on the writing surface 102 without the aid of a hard support surface. In particular embodiments of the invention, the erasable writing surface 102 can display writing on both sides allowing the holder to display two messages by displaying the appropriate side of the sign 100.

In particular embodiments, the writing surface 102 is made from polystyrene, though other suitable materials such as certain plastics may also be used. Typically, the polystyrene writing surface 102 is white or off-white, but, with a marker of suitable color, the writing surface 102 may be made in any color. Further, the polystyrene or plastic writing surface 102 may have a matte finish to enhance readability. In certain embodiments, the thickness of the polystyrene writing surface 102 is between 0.015 and 0.040 of an inch, with a thickness of between 0.020 and 0.035 of an inch, with 0.030 of an inch being a typical thickness.

At this thickness, for example, the writing surface 102 is self-supporting, meaning that no rigid structural support members are needed to display the sign 100 in an outdoor environment. In a particular embodiment, the writing surface 102 is self-supporting when in a flattened state, such that the writing surface 102 can be rolled out and displayed in an outdoor environment, such as a sports stadium. The self-supporting writing surface 102 is configured to withstand exposure to harsh weather without sustaining damage, and still permitting the user to display the sign 100. However, as illustrated in FIG. 1B, the self-supporting writing surface 102 is also configured to be readily compactable, and can be quickly rolled into a substantially cylindrical shape for easy transport. Further, in this configuration, the sign 100 is lightweight, durable, and reasonably inexpensive to produce. This allows for the sign 100 to be produced in a range of sizes and shapes.

In a particular embodiment, the sign 100 is approximated 32 inches long by 22 inches tall. However, the design disclosed herein can be made in much larger dimensions or in smaller sizes, wherein all, but extremely large versions of the various embodiments are suitable for use and display by an individual. For example, in an embodiment, the self-supporting, erasable writing surface 102 is between 11 and 36 inches in length, and between 8 and 26 inches in width, being made to be displayed by an individual. However, a portable, erasable sign 100 configured to be displayed by a group of two or more individuals may have a self-supporting, erasable writing surface 102 that is between five and 10 feet in length, and between 30 and 50 inches in width.

Typical shapes for the writing surface 102 are rectangular or oval. However, it is envisioned that the writing surface 102 may also take on special shapes in relation to a specialized use or particular event. For example, signs 100 sold for a particular event may be made in the shape of a team mascot or logo. For signs 100 to be used primarily at sporting events, the sign 100 may come with the logo or name of a particular sports team imprinted on the sign.

As shown in the drawings, an opening 104 may be placed at one end or at both ends of the writing surface. As shown, the openings 104 may be circular or elongated ovals, as shown in FIG. 2. The openings 104 serve as fingerholds to facilitate the holding and display of the sign. In some embodiments, a center of the opening 104 is within four inches of a perimeter, such as the ends on either side of the self-supporting, erasable writing surface 102. The openings 104 also allow the sign to be hung and displayed in one location, on a wall for example, when not being used at a public gathering or event.

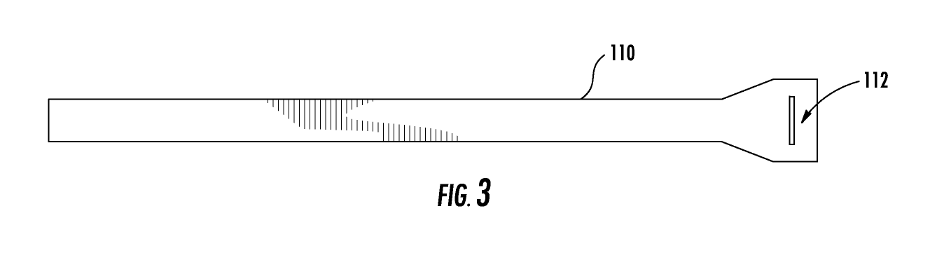

A holding strap, for example, may include a fastening tape having two strips of material attached to the writing surface 102. One of the strips of material has a plurality of small, flexible hooks, while the other strip of material has a dense pile, such that the two strips interlock when pressed together. Such a strap, often referred to as a Velcro strap, or, alternatively, an elastic band may be placed through one of the openings 104. When the portable sign 100 is rolled up, the strap or band can be placed around the sign 100 to hold it in the rolled-up position. In alternate embodiments, other means of securing the portable sign 100 in the rolled-up position are used, including, but not limited to, self-coiling bands, magnets, and adhesives. For example, another type of holding strap 110, such as that illustrated in FIG. 3, is separate from the writing surface 102. In this embodiment, the holding strap 110 has a fastening mechanism 112, and is configured to wrap around and secure the writing surface 102 in the rolled-up position.

In an alternate embodiment of the invention, the writing surface 102 is self-supporting and can be maintained in the rolled-up position without any fastening apparatus, such as straps or elastic bands. In at least one of these embodiments, the writing surface 102 is made from layered, flexible stainless steel or from plastic bi-stable spring bands, sealed within a polystyrene or plastic covering. This material allows the writing surface 102 to be adjusted between two positions, i.e., flat for writing and display and rolled up for transport, without any additional components or fastening members, such as straps or fastening tape, to secure the writing surface 102 in the rolled up position.

The writing surface 102 is erasable for many types of commercially available marking pens, such as dry erase, wet erase, washable markers, and window markers. This allows for the sign 100 to be quickly and easily changed during the event in which it is being used, so that numerous messages can be communicated during a single event. In particular embodiments of the invention, the writing surface 102 has a surface layer made from a thin film of non-porous material that facilitates the removal of ink from the surface layer.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A portable, erasable sign comprising:
a self-supporting, erasable writing surface, wherein the writing surface is configured to be sufficiently rigid such that no support members are used when displaying the writing surface in a flattened configuration;
and wherein the writing surface is sufficiently flexible such that the writing surface can be rolled in to a substantially cylindrical shape when the writing surface is not being displayed.

2. The portable, erasable sign of claim 1, wherein the self-supporting, erasable writing surface includes at least one opening to facilitate holding of the sign by hand.

3. The portable, erasable sign of claim 2, wherein a center of the at least one opening is within four inches of a perimeter of the self-supporting, erasable writing surface.

4. The portable, erasable sign of claim 2, wherein the self-supporting, erasable writing surface has an elongated oval shape.

5. The portable, erasable sign of claim 1, further comprising one of a holding strap and an elastic band to secure the self-supporting, erasable writing surface in a rolled-up position.

6. The portable, erasable sign of claim 5, wherein the holding strap comprises a fastening tape with two strips of material attached to the self-supporting, erasable writing surface, one of the strips of material having a plurality of small, flexible hooks, the other strip of material having a dense pile, wherein the two strips interlock when pressed together.

7. The portable, erasable sign of claim 5, wherein the holding strap comprises a strap separate from the self-supporting, erasable writing surface, the strap having a fastening mechanism and configured to wrap around and secure the self-supporting, erasable writing surface in the rolled-up position.

8. The portable, erasable sign of claim 1, wherein the self-supporting, erasable writing surface is made from one of polystyrene and plastic.

9. The portable, erasable sign of claim 8, wherein the thickness of the self-supporting writing surface is between 0.015 and 0.040 of an inch.

10. The portable, erasable sign of claim 8, wherein the thickness of the self-supporting writing surface is between 0.020 and 0.035 of an inch.

11. The portable, erasable sign of claim 8, wherein the self-supporting, erasable writing surface comprises a dry-erase writing surface.

12. The portable, erasable sign of claim 8, wherein the self-supporting, erasable writing surface is between 11 and 36 inches in length, and between 8 and 26 inches in width.

13. The portable, erasable sign of claim 8, wherein the self-supporting, erasable writing surface is between five and 10 feet in length, and between 30 and 50 inches in width.

14. The portable, erasable sign of claim 8, wherein the self-supporting, erasable writing surface is made from either layered, flexible stainless steel or plastic bi-stable spring bands, sealed within a polystyrene or plastic covering.

15. The portable, erasable sign of claim 14, the self-supporting, erasable writing surface maintains it shape in both the flattened and rolled up positions without the use of any fastening device.

16. The portable, erasable sign of claim 8, wherein the self-supporting, erasable writing surface has a non-porous surface layer to facilitate the erasing of ink from the surface layer.

17. The portable, erasable sign of claim 1, wherein the self-supporting, erasable writing surface comprises a dry-erase writing surface on two sides.

18. The portable, erasable sign of claim 1, wherein the self-supporting, erasable writing surface is self-supporting when in a flattened state.
